(19) United States
(12) Patent Application Publication
(10) Pub. No.: US 2007/0284490 A1
(43) Pub. Date: Dec. 13, 2007

(54) Display Apparatus

(76) Inventor: Marc Cox, Buckinghamshire (GB)

Correspondence Address: CHRISTIE, PARKER & HALE, LLP, PO BOX 7068, PASADENA, CA, 91109-7068, US

(21) Appl. No.: 11/547,122

(22) PCT Filed: Apr. 1, 2005
(86) PCT No.: PCT/GB05/01310

§ 371 Date: Jul. 20, 2007

(30) Foreign Application Priority Data
Apr. 3, 2004 (GB) 0407673.3

(51) Int. Cl. F16M 11/00

(52) U.S. Cl. 248/174

(57) ABSTRACT

A self-erecting display device is disclosed, comprising a display panel supported by a collapsible structure secured to its reverse side, the collapsible structure comprising an elongate back panel and a pair of side panels integrally hinged to the respective longitudinal edges of the back panel, the side panels provided with means for receiving part of a resilient means whereby at least one resilient means is applied between respective parts of the side panels so as to draw the side panels towards each other when the display structure is erected, and at least one spacer element mounted by means of the resilient means and adapted to lie against the elongate back panel when the structure is un-erected and to be spaced away from the back panel, supported by the resilient means and abutting the side panels when the device is erected.

This invention relates to display apparatus. In particular, it relates to a self-erectable display apparatus in the form of a planar structure which can be formed in the shape of a particular image, such as a life-size image of a person and which is self-erectable but which is also foldable so as to be conveniently transported and stored when not in use.

Such large image display planar structure are typically used for advertising signs or to provide eye-catching life-size or greater scale images of personalities or products and may be situated at shops, petrol (gasoline) stations, museums, entertainment places and many other locations. The signs may be simply formed as a single unfoldable large size sheet having a rear strut or other support structure enabling it to stand upright. More preferably, however, such devices are folded so that they can be more easily transported and stored when not in use.

This may be achieved by folding the display sheet itself and providing a separate, possibly foldable or collapsible support structure.

Alternatively, attempts have been made in the past to provide assemblies which include the display sheet and a support structure as a single foldable assembly which can be transported and stored in the folded state and then erected when necessary. These can include a display panel supported by a collapsible frame secured to the reverse side of the display panel, the frame and panel being foldable. Examples of such assemblies are shown in U.S. Pat. No. 3,727,874, U.S. Pat. No. 3,508,734 and U.S. Pat. No. 6,508,023.

Such systems typically include a front display panel and rear support assembly comprising a frame having an elongate back panel secured to the back of the display panel and a pair of side panels integrally hinged to the respective longitudinal edges of the back panel, which side panels can be folded away from the display panel so that their bottom edges support the device. Transverse fold lines formed in the support frame and a display panel can divide the structure into a plurality of foldable sections. Resilient means such as elastic bands may be used to hold the side panels together in the supporting position and spacer bars may be applied between the side panels to prevent over-revolution of the side panels and to therefore ensure maximum support.

U.S. Pat. No. 6,508,023 shows such a system in which resilient bands extend between the side panel and pass through spacer bars such that when the apparatus is allowed to unfold, the resilient bands automatically pull the side panel so as to extend away from the display panel and the spacer bars are clamped between the side panels. The spacer bars, however, are mounted by means of the resilient bands and mounting holes in the bars such that the bars lie in a generally horizontal disposition, with their main faces horizontal when erected. When such an apparatus is desired to be folded up, it may be necessary to manually rotate each spacer bar by about 90° so that it lies flat against the longitudinal panel of the support and also, since the spacer bar has to rotate, there may be times when this can catch or snag thus reducing the speed and efficiency by which the display means can be erected.

The present invention arose in an attempt to provide an improved self-erecting display device.

According to the present invention there is provided a self-erecting display device, comprising a display panel supported by a collapsible structure secured to its reverse side, the collapsible structure comprising an elongate back panel and a pair of side panels integrally hinged to the respective longitudinal edges of the back panel, the side panels provided with means for receiving part of a resilient means whereby at least one resilient means is applied between respective parts of the side panels so as to draw the side panels towards each other when the display structure is erected, and at least one spacer element mounted by means of the resilient means and adapted to lie against the elongate back panel when the structure is un-erected and to be spaced away from the back panel, supported by the resilient means and abutting the side panels when the device is erected.

Preferably, a plurality of resilient means and spacer elements are provided. They may be vertically arranged.

Preferably, each spacer element is a rigid bar.

Preferably, each spacer bar lies generally parallel to the elongate back panel in the erected mode as well as the non-erect mode.

The display panel and collapsible frame preferably includes one or more transverse fold lines enabling the device to be folded and transported in a flattened disposition.

In a further aspect, the present invention comprises a display structure comprising any one or more of the novel features disclosed herein.

Embodiments of the invention will now be described, by way of example only, with reference to the accompanying drawings, in which:

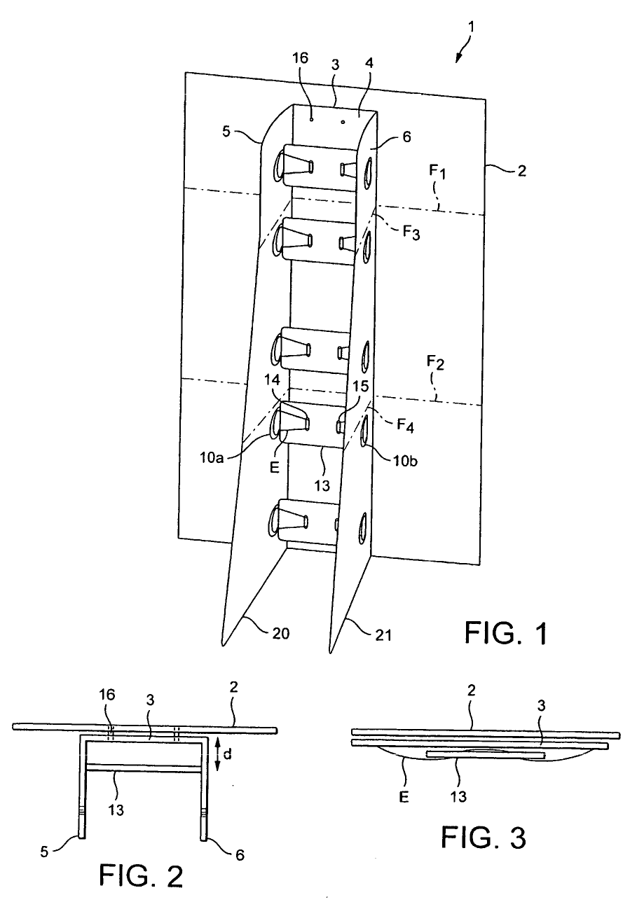

FIG. 1 shows a rear view of a display device;

FIG. 2 shows a plan (end) view of the device when erected;

FIG. 3 shows an end view of the device when folded;

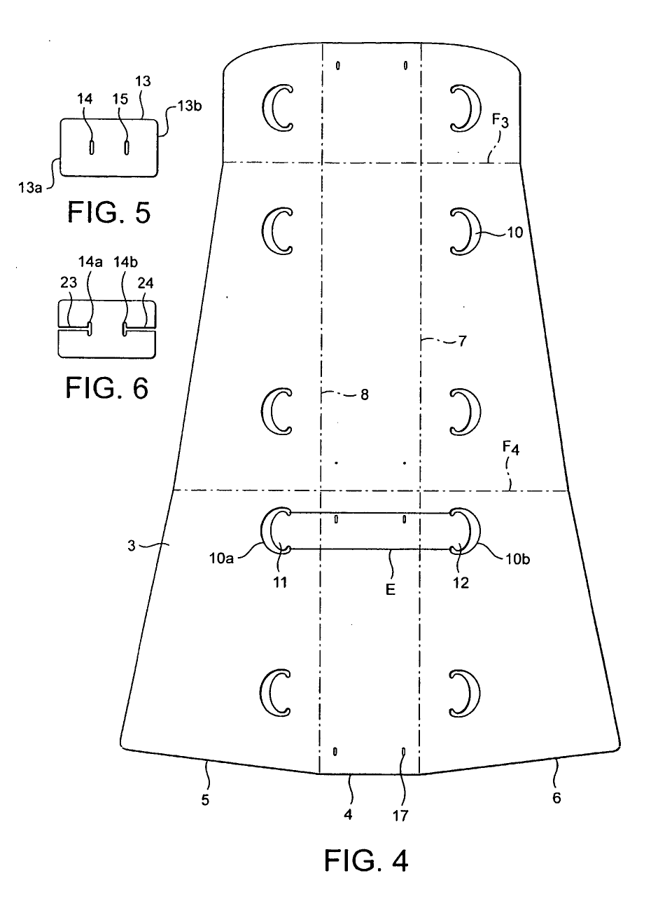

FIG. 4 shows a support frame;

FIG. 5 shows a spacer element;

FIG. 6 shows an alternative spacer element; and

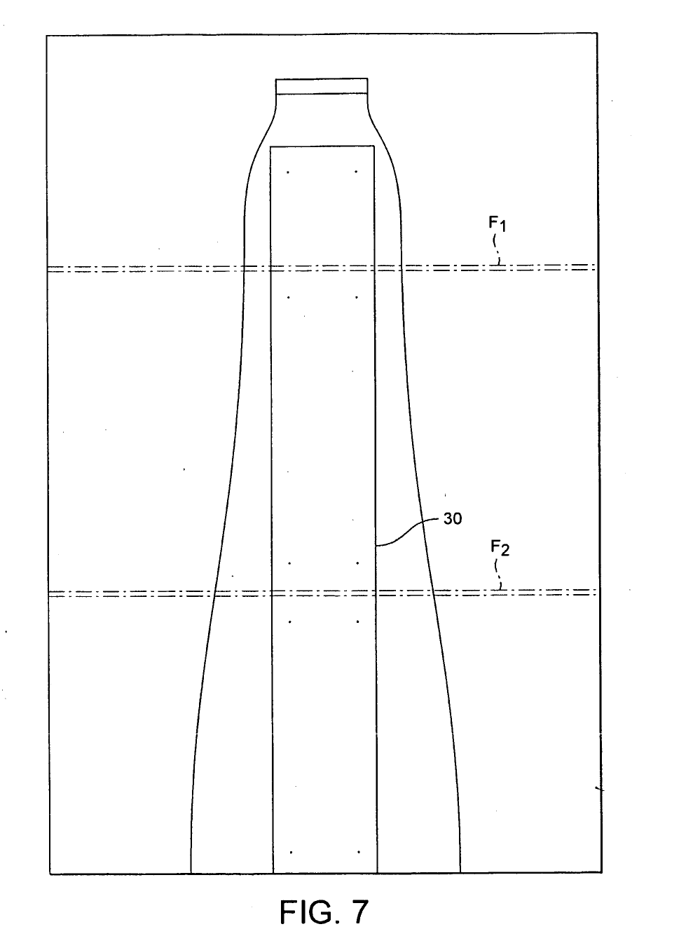

FIG. 7 shows a blank from which a display panel can be cut.

Referring to the drawings, a display device 1 comprises a front panel 2 which is shown as being rectangular in FIG. 1 but which may be in any shape or may be cut to a specific shape and size, for example a life-size image of a person, an image of a product or any other shape, which may have any image printed or otherwise affixed upon it so as to bear said image. The panel 2 is connected to a support frame 3. The support frame is shown more clearly in FIG. 4 and a panel from which the panel 2 may be formed is shown more clearly in FIG. 7. The panel may alternatively be formed from two or more panels.

The support frame comprises an elongate back panel 4 and two side panels 5 and 6. These form part of an integral sheet with the back panel 4 but are in effect hingeably attached at fold line 7 and 8. Each of the side panels includes a plurality of longitudinally spaced slots 10 which may be any desired shape but in the example shown are generally crescent shaped. They are shaped in any suitable manner so that a resilient means, for example an elastic band, can be mounted between respective pairs of slots such as pair 10a and 10b. An elastic band E is shown in FIG. 4, by way of example, showing how respective parts of the band are held by protruding arcuate portions 111 and 12 of the side panels. Thus, it will be appreciated that slots 10 may be U-shaped or otherwise shaped so that they include a projection which can mount an endless band such as an elastic band. In other embodiments, however, the slots may simply be holes and a single resilient band may be mounted between the holes and perhaps filled in by knots at each, for example. Any other means of resiliently drawing the ends towards one another may be used.

In yet further embodiments, resilient strips or members may simply be attached at their ends to the side panels, eg by adhesive or pins.

The support also includes a plurality of spacer elements 5 in the form of generally rectangular planar sheets 13, each bearing two apertures 14, 15 through which resilient means such as elastic bands can fit. These are of a rigid material, eg cardboard, and may be the same type of material as the other panels or a different one.

Referring now to FIG. 1, the support frame is mounted by affixing the elongate back panel to the rear of the display panel 2. This may be done by means of rivets 16 through holes 17 adhesive or other means or a combination of methods. The side panels 5 and 6 are not fixed directly to the panel 2.

Resilient means, eg elastic bands, are connected between each respective pair of apertures such as apertures 10a and 10b and are also fed through the apertures 14 and 15 in a respective spacer element 13. Thus, in FIG. 1, the elastic band E extends from slot 10a through aperture 14 of spacer element 13 across the back of the spacer element out to the front of the spacer element again through aperture 15 and is held at groove 10b. The grooves are most preferably such that the bands, and therefore the spacer elements, lie parallel to the back panel and therefore parallel to the display panel 2.

It is noted that both the display panel 2 and the support structure 3 are provided with transverse fold lines F1, F2, F3, F4 which enable the structure to be folded. When the structure is erect, the elastic bands E tend to pull the side panels 5 and 6 towards one another, ie such that their transverse ends rotate or hinge away from panel 2, until they abut the edges 13a, 13b of the spacer bars. The grooves are positioned in the side panels such that their ends are spaced a distance D from the hinge or fold lines 7, 8 and therefore at the erect position the spacer bars have been pulled backwards and lie spaced away from back panel 3. This is shown more clearly in FIG. 2. In this position, the structure can stand on its own accord and is supported by the side supports 5 and 6 spaced apart by the spacer bars and elastic bands. The bottom edges 20 and 21 of the side panel preferably make an acute angle with the hinge lines 7 and 8 where they can connect to the back panel so that in use, when these edges lie flat upon the ground, the back panel and therefore the display panel lean back slightly. This aids stability and aids presentation of the image bourn by the display panel. Alternatively, the bottom edges 20 and 21 may make a 90° angle with the hinge lines 7 and 8.

If the side panels are folded so as to lie adjacent to the display panel 2, then the elastic bands will push the spacer bar such that they also lie flat adjacent to back panel 3, as is shown in FIG. 3. Once in this position, the entire apparatus can be folded about transverse fold lines F1, F2, F3, F4 to fold the structure into a relatively compact unit. Upon release of the structure from this folded arrangement, it automatically erects into the erected position of FIG. 1 by virtue of the resilient bands tending to pull the side panels together, until they abut the spacer elements.

Thus, the spacer elements with this arrangement are maintained at a disposition parallel to the back panel 3 and do not need to rotate or be manually moved between positions.

Furthermore, since longitudinal contact is made between the whole edge 13a or 13b of the spacer with each of the side panels, a rigid support is obtained which resists torsional or tilting movement of the entire display structure. With prior art systems in which spacer bars are mounted in a generally horizontal manner with their main faces lying horizontal, in effect box sections are provided which can tilt since the contact in a longitudinal sense between the spacer bars and the side panels is only a point one, whereas in the present invention it is a line contact.

Many different designs of spacer bar may be used. FIG. 5 shows an alternative design in which a cut of finite width 23 is formed between each aperture 14a, 15a and the edges of the spacer element. This can ease insertion of the elastic band. Other cut geometries and configurations may be used. Alternatively, the elastic band may simply be affixed or adhered to each spacer element by any other suitable means. By varying the lengths of the spacer element various angles between the side panels and the display can be achieved. This allows for differing degrees of general stability and/or balance.

FIG. 7 shows a blank from which the actual display panel may be formed. In this case, a display in the form of a bottle 25 is shown. It is useful to indicate on such a blank an area, as shown by the highlighted area 30 which indicates the minimum size of image possible, and/or the area into which the outer profile should not be cut without revealing the strut and support mechanism of FIGS. 4 and 5.

Any or all of the display panels, support panels and spacer bars are preferably of a card or cardboard material, or may be of plastics material, wood, metal or other materials or a combination of materials.

Other devices or structures may be attached to the display panels, e.g. a trough-like dispenser for books, CDs, DVDs or the like.

1. A self-erecting display device, comprising a display panel supported by a collapsible structure secured to its reverse side, the collapsible structure comprising an elongate back panel and a pair of side panels integrally hinged to the respective longitudinal edges of the back panel, the side panels provided with means for receiving part of a resilient means whereby at least one resilient means is applied between respective parts of the side panels so as to draw the side panels towards each other when the display structure is erected, and at least one spacer element mounted by means of the resilient means and adapted to lie against the elongate back panel when the structure is un-erected and to be spaced away from the back panel, supported by the resilient means and abutting the side panels when the device is erected.

2. A display device as claimed in claim 1, including a plurality of resilient means and a plurality of spacer elements.

3. A display device as claimed in claim 2, wherein the spacer elements are vertically arranged.

4. A display device as claimed in claim 1, wherein each spacer element is a rigid bar.

5. A display device as claimed in claim 1, wherein the or each spacer element lies generally parallel to the elongate back panel in the erected mode as well as the non-erected mode.

6. A display device as claimed in claim 1, wherein the display panel and collapsible structure include one or more transverse fold lines enabling the device to be folded and transported in a flattened disposition.

7. A display device as claimed in claim 1, wherein the display panel is shaped to form a desired image.

8. A display device as claimed in claim 1, wherein the display panel bears a desired image.

9. A display device as claimed in claim 1, wherein the resilient means are mounted via slots in the side panels.

10. A display device as claimed in claim 5, wherein the main face of the spacer element lies generally parallel to the back panel in both the erected and non-erected mode.
